(19) United States
(12) Patent Application Publication
(10) Pub. No.: US 2008/0165660 A1
(43) Pub. Date: Jul. 10, 2008

(54) OBJECTIVE LENS SYSTEM AND OPTICAL PICKUP INCLUDING THE SAME

(76) Inventors: Katsuhiko Hayashi, Osaka (JP); Yasuhiro Tanaka, Hyogo (JP); Michihiro Yamagata, Osaka (JP); Fumitomo Yamasaki, Nara (JP)

Correspondence Address: MCDERMOTT WILL & EMERY LLP, 600 13TH STREET, NW, WASHINGTON, DC, 20005-3096, US

(21) Appl. No.: 11/969,417

(22) Filed: Jan. 4, 2008

Related U.S. Application Data
(60) Provisional application No. 60/878,401, filed on Jan. 4, 2007.

(51) Int. Cl. G11B 7/135

(52) U.S. Cl. 369/112.08

(57) ABSTRACT

The present invention provides an objective lens system for forming a spot of a laser beam of λ wavelength on a first information recording surface through a disc protective layer having a first thickness and a second information recording surface through a disc protective layer having a second thickness greater than the first thickness, the objective lens system including: an objective lens having at least one diffraction structure for deflecting incident light by diffraction and at least two refractive surfaces for deflecting the incident light by refraction, wherein the diffraction structure divides the incident light into m1^{th} order diffracted light (m1 is an integer) corresponding to the first information recording surface and m2^{th} order diffracted light (m2 is an integer different from m1) corresponding to the second information recording surface and has negative power to diverge the m2^{th} order diffracted light.

### CROSS-REFERENCE TO RELATED APPLICATION

The present application benefits from U.S. Provisional Patent Application No. US60/878,401 filed on Jan. 4, 2007.

### BACKGROUND OF THE INVENTION

1. Field of the Invention

The present invention relates to an objective lens system and an optical pickup including the same.

2. Description of Related Art

Optical discs having high recording density and large capacity have been proposed as a novel information recording medium. At present, due to the existence of multiple standards for the optical discs, there are various kinds of optical discs different in thickness of a protective layer (substrate thickness), wavelength of an applicable laser beam and numerical aperture (NA) of an objective lens system used to gather the laser beam.

There are different standards of high density optical discs using a laser beam of about 400 nm wavelength, i.e., a Blu-Ray® disc (hereinafter may be abbreviated as BD) corresponding to a numerical aperture (NA) of about 0.85 on the image side of an objective lens system and having a protective substrate of about 0.1 mm thick formed on an information recording surface and an HD DVD® (hereinafter may be referred to HD DVD) corresponding to a numerical aperture (NA) of about 0.65 on the image side of the objective lens system and having a protective substrate of about 0.6 mm thick formed on an information recording surface.

In general, an optical pickup (optical disc device) designed for reproduction exclusively from a certain kind of optical disc cannot reproduce data from other kinds of optical discs in a suitable manner. In connection to this, compatible technologies for realizing reproducing and recording (writing) from and on multiple kinds of optical discs have been under development. According to one of the technologies, a bifocal lens provided with a hologram on one of the lens surfaces for focusing a light beam on two focal points is used as an objective lens system of an optical pickup such that information is read from two kinds of discs different in thickness of the protective layer.

For example, Patent Literature 1 (Japanese Unexamined Patent Publication No. 9-179020) discloses an objective lens system applicable to both of a so-called DVD having a protective substrate of about 0.6 mm thick formed on the information recording surface and a so-called CD having a protective substrate of about 1.2 mm thick formed on the information recording surface by using a red laser beam of about 680 nm wavelength. A bifocal lens disclosed by Patent Literature 1 is configured to have a focal length for a higher order diffracted light shorter than a focal length for a lower order diffracted light such that the shift of the focal point due to the change of the wavelength is minimized.

### SUMMARY OF THE INVENTION

From the viewpoint of compatibility with BD and HD DVD, the next-generation high density optical discs, it is not practical and easy to provide a diffraction structure covering all the effective diameter of the lens for the BD having a higher NA because the diffraction structure has to be provided even on the peripheral area of the lens where the angle of inclination of is steep.

If the technology described in Patent Literature 1 is adopted to reduce the focal length for a higher order diffracted light corresponding to the HD DVD, the working distance for the HD DVD is reduced. The reduced working distance is not preferable because the risk of collision of the objective lens system with the disc increases.

Under these circumstances, an object of the present invention is to provide an objective lens system which allows recording and reproducing on and from multiple high density optical discs of different standards in an excellent manner while a sufficient working distance is ensured and an optical pickup using the objective lens system.

To achieve the object, the objective lens system of the present invention is configured to form a spot of a laser beam of λ wavelength on a first information recording surface through a disc protective layer having a first thickness and a second information recording surface through a disc protective layer having a second thickness greater than the first thickness. The objective lens system includes an objective lens having at least one diffraction structure for deflecting incident light by diffraction and at least two refractive surfaces for deflecting the incident light by refraction, wherein the diffraction structure divides the incident light into m1^{th} order diffracted light (m1 is an integer) corresponding to the first information recording surface and m2^{th} order diffracted light (m2 is an integer different from m1) corresponding to the second information recording surface and has negative power to diverge the m2^{th} order diffracted light.

The objective lens system of the present invention makes it possible to perform recording and reproducing on and from multiple high density optical discs of different standards in an excellent manner while a sufficient working distance is ensured and provide an optical pickup using the objective lens system.

### BRIEF DESCRIPTION OF THE DRAWINGS

FIG. 1 is a schematic view illustrating an optical pickup of Embodiment 1.

FIG. 2 is a schematic view illustrating an objective lens system of Embodiment 2.

FIGS. 3A and 3B are ray diagrams according to Example 1.

FIGS. 4A to 4D are graphs illustrating aberrations according to Example 1.

FIGS. 5A and 5B are ray diagrams according to Example 2.

FIGS. 6A to 6D are graphs illustrating aberrations according to Example 2.

### DETAILED DESCRIPTION OF THE INVENTION

Hereinafter, embodiments of the present invention will be described with reference to the drawings.

### Embodiment 1

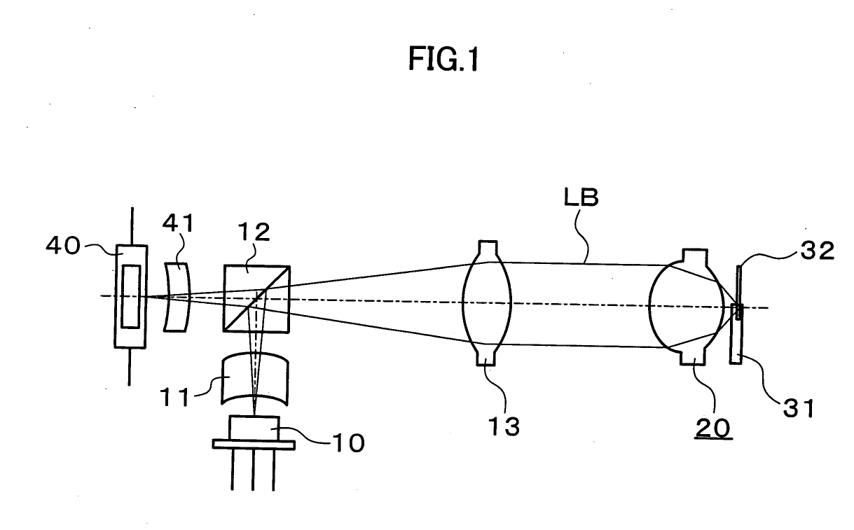

FIG. 1 is a schematic view of an optical pickup of Embodiment 1 of the present invention. Referring to FIG. 1, the optical pickup includes a light source 10, a beam forming lens 11, a polarizing beam splitter 12, a collimator lens 13, an objective lens 20, a detection lens 41 and a detector 40. A first optical recording medium protective layer 31 is a protective layer of an HD DVD and a second optical recording medium protective layer 32 is a protective layer of a BD.

The light source 10 is a semiconductor laser which emits a laser beam of 408 nm wavelength. The beam forming lens 11 is an anamorphic lens having different focal lengths in the directions parallel and perpendicular to the paper and having a round section perpendicular to the optical axis of the laser beam emitted from the light source 10. The polarizing beam splitter 12 is a cube beam splitter containing a polarization split surface which reflects a laser beam having a particular polarization direction and transmits a laser beam orthogonal to the polarization direction.

The collimator lens 13 receives a divergent beam and emits it as a substantially collimated beam. The objective lens 20 is a single lens provided with a diffraction structure. The objective lens 20 as a single lens functions as an objective lens system. Details of the objective lens 20 will be explained later. The detection lens 41 gathers a laser beam not reflected on the polarizing beam splitter but transmitted through it on a light receiving surface of the detector 40. The detector 40 generates an electric signal from the laser beam gathered by the detection lens 41.

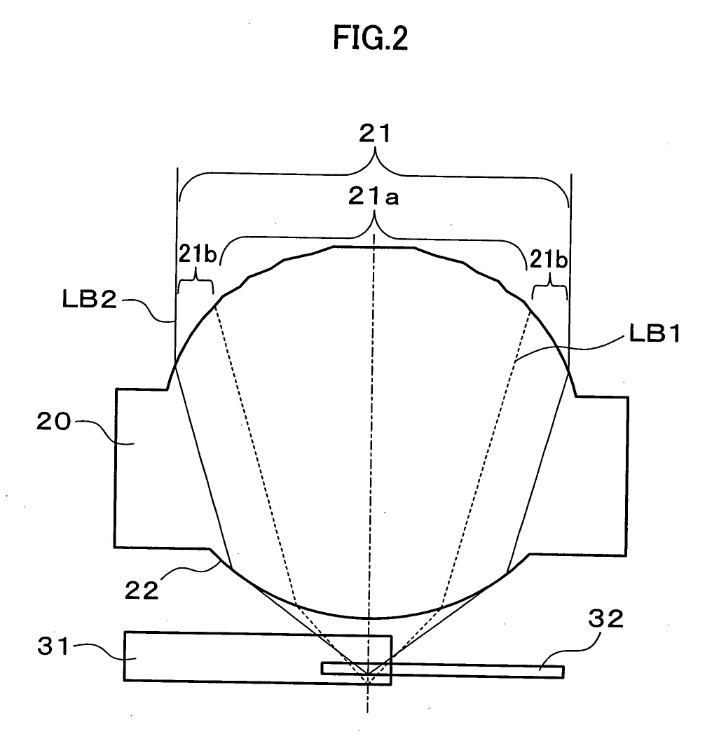

FIG. 2 is a schematic view illustrating an objective lens system of Embodiment 1 of the present invention. Referring to FIG. 2, the objective lens 20 is a single lens having an entrance surface 21 and an exit surface 22 which are both aspheric refractive surfaces and a diffraction structure 21a formed on the middle of the objective lens 20 including the optical axis. A peripheral zone 21b around the diffraction structure is aspheric and not diffractive. The diffraction structure 21a occupies an area of the lens including the optical axis center and corresponding to NA of up to 0.65, while the peripheral zone 21b covers an area of the lens corresponding to NA of 0.65 to 0.86. The diffraction structure 21a is shared by the BD and the HD DVD and 0^{th} order diffracted light is used for detection of BD signals, while 1^{st} order diffracted light is used for detection of HD DVD signals. The peripheral zone 21b is exclusive for the BD and connected to the diffraction structure 21a with a level difference of integral multiple of the wavelength such that a phase of a wavefront of light incident on the peripheral zone 21b is aligned with a phase of a wavefront of the 0^{th} order diffracted light on the inner circumference of the peripheral zone 21b.

Referring to FIGS. 1 and 2, the effect of the optical pickup of Embodiment 1 will be described. In use of the BD, a laser beam LB2 of 408 nm wavelength emitted from the light source 10 and converted to a collimated beam enters the objective lens 20. A portion of the laser beam LB2 incident on the diffraction structure 21a on the entrance surface of the objective lens 20 is divided into 0^{th} order diffracted light and 1^{st} order diffracted light by the diffraction structure 21a. The 0^{th} order diffracted light is used as signal light for the BD.

A portion of the laser beam LB2 incident on the peripheral zone 21b of the entrance surface of the objective lens 20 is refracted by the aspherical surface and aligned with the phase of the wavefront of the 0^{th} order diffracted light on the inner circumference of the peripheral zone 21b. Then, the laser beam is gathered through the protective layer 32 to form a good spot on the information recording surface of the BD. The laser beam is then reflected on the information recording surface and travels along the optical path in the reverse direction to reach the polarizing beam splitter 12. If a wave plate (not shown) is arranged to make the polarization direction of the outgoing beam orthogonal to that of the returning beam, the outgoing beam and the returning beam are separated by the polarizing beam splitter 12. After passing through the polarizing beam splitter 12, the laser beam passes through the detection lens 41 and arrives at the detector 40.

In use of the HD DVD, a laser beam LB1 of 408 nm wavelength emitted from the light source 10 and converted to a collimated beam enters the objective lens 20. A portion of the laser beam LB1 incident on the diffraction structure 21a on the entrance surface of the objective lens 20 is divided into 0^{th} order diffracted light and 1^{st} order diffracted light by the diffraction structure 21a. The 1^{st} order diffracted light is used as signal light for the HD DVD.

Then, the laser beam LB1 is refracted by the aspherical surface, gathered through the protective layer 31 and forms a good spot on the information recording surface of the HD DVD. The laser beam is then reflected on the information recording surface and travels along the optical path in the reverse direction to reach the polarizing beam splitter 12. If a wave plate (not shown) is arranged to make the polarization direction of the outgoing beam orthogonal to that of the returning beam, the outgoing beam and the returning beam are separated by the polarizing beam splitter 12. After passing through the polarizing beam splitter 12, the laser beam passes through the detection lens 41 and arrives at the detector 40.

A portion of the laser beam LB1 incident on the peripheral zone 21b of the entrance surface of the objective lens 20 is radiated to a completely different direction from the information recording surface. Therefore, the portion does not contribute to the signal detection at all.

The collimator lens 13 moves along the optical path to change the parallelism of the laser beam entering the objective lens 20 (diversion or conversion) and corrects spherical aberration caused by the change of the thickness of the disc protective layer.

The peripheral zone 21b of the objective lens of Embodiment 1 has negative power to diverge the laser beam. Due to the negative power of the peripheral zone 21b, the focal length for the HD DVD is made longer than that for the BD. Therefore, the working distance for the HD DVD having a thicker protective layer is easily ensured. At the same time, the working distance for the BD is relatively reduced. Thus, the objective lens is provided with superior optical characteristics and manufacturing tolerances is reduced.

Use of the 0^{th} and 1^{st} order diffracted lights for the BD and the HD DVD, respectively, is preferable from the aspect of ease of manufacture because an area for forming the diffraction structure is kept small. However, the 1^{st} order diffracted light may be used for the BD and the 0^{th} order diffracted light may be used for the HD DVD. In general, m1^{th} order diffracted light is used for the BD (m1 is an integer) and m2^{th} order diffracted light is used for the HD DVD (m2 is an integer different from m1).

If the BD is used for recording/reproducing and the HD DVD is used exclusive for reproducing, the above-described combination of the diffracted lights for the BD and the HD DVD is applied. As a result, the blaze depth of the diffraction structure is reduced and the manufacture of the diffraction structure becomes easy. The optical pickup of Embodiment 1 is an infinite system for both of the BD and the HD DVD (collimated light enters the objective lens). Therefore, if the objective lens system in the optical pickup is shifted in the disc radius direction with respect to the optical axis for tracking, deformation of the spot caused by the aberration is less likely to occur. However, the optical pickup may be a finite system (divergent or convergent light enters the objective lens) for one or both of the BD and the HD DVD.

The optical pickup of Embodiment 1 is directed to the BD and HD DVD only. However, the optical pickup may be a so-called dual lens system provided with another objective lens on the same lens actuator for compatible use of DVD and CD. Alternatively, a beam expander may be interposed between the collimator lens and the objective lens system for the same function.

A lens for correction of chromatic aberration may be provided on the optical path of the outgoing light between the light source 10 and the information recording surface. Further, a functional element which does not have any effect on the transmissive wavefront aberration may be arranged on the optical path.

Hereinafter, the conditions that should be satisfied by the objective lens system of Embodiment 1 will be explained. In the case where the objective lens system includes an objective lens having at least one diffraction structure for deflecting incident light by diffraction and at least two refractive surfaces for deflecting the incident light by refraction, the diffraction structure divides the incident light into m1^{th} order diffracted light (m1 is an integer) corresponding to a first information recording surface and m2^{th} order diffracted light (m2 is an integer different from m1) corresponding to a second information recording surface and the diffraction structure has negative power to diverge the m2^{th} order diffracted light, the objective lens system preferably satisfies the following condition:

−0.8<ΦD/ΦL<−0.2 (1)

wherein ΦD is power of the diffraction structure on the m2^{th} order diffracted light and

ΦL is synthetic power of the refractive surfaces.

The condition (1) defines the ratio between the power of refraction of the lens and the power of the diffraction structure. When the ratio is below the lower limit of the condition (1), the negative diffraction power becomes too high to easily perform the correction of spherical aberration and off-axis coma aberration. On the other hand, if the ratio exceeds the upper limit of the condition (1), the negative diffraction power becomes too low to easily ensure the working distance for gathering light on the second information recording surface.

In the case where the objective lens system includes an objective lens having at least one diffraction structure for deflecting incident light by diffraction and at least two refractive surfaces for deflecting the incident light by refraction, the diffraction structure divides the incident light into m1^{th} order diffracted light (m1 is an integer) corresponding to a first information recording surface and m2^{th} order diffracted light (m2 is an integer different from m1) corresponding to a second information recording surface and the diffraction structure has negative power to diverge the m2^{th} order diffracted light, the objective lens system preferably satisfies the following condition:

0.2<|ΔCA1−ΔCA2|<0.5 (2)

wherein ΔCA1 is axial chromatic aberration for the m2^{th} order diffracted light and

ΔCA2 is axial chromatic aberration for the m2^{th} order diffracted light.

The condition (2) defines the difference between the axial chromatic aberration for the m1^{th} order diffracted light and the axial chromatic aberration for the m2^{th} order diffracted light. If the value |ΔCA1−ΔCA2| is below the lower limit or exceeds the upper limit of the condition (2), the axial chromatic aberration caused by the change of the thickness of the substrate is not easily corrected.

In the case where the objective lens system includes an objective lens having at least one diffraction structure for deflecting incident light by diffraction and at least two refractive surfaces for deflecting the incident light by refraction, the diffraction structure divides the incident light into m1^{th} order diffracted light (m1 is an integer) corresponding to a first information recording surface and m2^{th} order diffracted light (m2 is an integer different from m1) corresponding to a second information recording surface and the diffraction structure has negative power to diverge the m2^{th} order diffracted light, the objective lens system preferably satisfies the following condition:

1.03<f1/f2<1.2 (3)

wherein f1 is a focal length of the lens for the m1^{th} order diffracted light,

f2 is a focal length of the lens for the m2^{th} order diffracted light and
m1>m2.

The condition (3) defines the ratio between the focal length of the lens for the m1^{th} order diffracted light and that for the m2^{th} order diffracted light. When the ratio is below the lower limit of the condition (3), the focal length of the lens for the m1^{th} order diffracted light becomes too small to easily keep a sufficient working distance. On the other hand, if the ratio exceeds the upper limit of the condition (3), the focal length of the lens for the m1^{th} order diffracted light becomes too large to easily reduce the thickness of the optical pickup.

In the case where the objective lens system includes an objective lens having at least one diffraction structure for deflecting incident light by diffraction and at least two refractive surfaces for deflecting the incident light by refraction, the diffraction structure divides the incident light into m1^{th} order diffracted light (m1 is an integer) corresponding to a first information recording surface and m2^{th} order diffracted light (m2 is an integer different from m1) corresponding to a second information recording surface and the diffraction structure has negative power to diverge the m2^{th} order diffracted light, the objective lens system preferably satisfies the following condition:

0.9<f2/f1<1.1 (4)

wherein f1 is a focal length of the lens for the m1^{th} order diffracted light and

f2 is a focal length of the lens for the m2^{th} order diffracted light.

The condition (4) defines the ratio between the focal length of the lens for the m1^{th} order diffracted light and that for the m2^{th} order diffracted light. When the ratio is below the lower limit of the condition (4), the focal length of the lens for the m1^{th} order diffracted light becomes too small to easily keep a sufficient working distance. On the other hand, if the ratio exceeds the upper limit of the condition (4), the focal length of the lens for the m1^{th} order diffracted light becomes too large to easily reduce the thickness of the optical pickup.

In the case where the objective lens system includes an objective lens having at least one diffraction structure for deflecting incident light by diffraction and at least two refractive surfaces for deflecting the incident light by refraction, the diffraction structure divides the incident light into m1^{th} order diffracted light (m1 is an integer) corresponding to a first information recording surface and m2^{th} order diffracted light (m2 is an integer different from m1) corresponding to a second information recording surface and the diffraction structure has negative power to diverge the m2^{th} order diffracted light, the objective lens system preferably satisfies the following condition:

R1/f1≧0.66 or R1/f2≧0.66 (5)

wherein R1 is a radius of curvature of the entrance surface of the lens,

f1 is a focal length of the lens for the m1^{th} order diffracted light and

f2 is a focal length of the lens for the m2^{th} order diffracted light.

The condition (5) defines the radius of curvature on the entrance surface of the lens. If the condition is not met, the radius of curvature on the entrance surface becomes too small. As a result, the manufacture of the objective lens system becomes difficult and the off-axial coma aberration becomes too large to put the objective lens system into practical use.

In the case where the objective lens system includes an objective lens having at least one diffraction structure for deflecting incident light by diffraction and at least two refractive surfaces for deflecting the incident light by refraction, the diffraction structure divides the incident light into m1^{th} order diffracted light (m1 is an integer) corresponding to a first information recording surface and m2^{th} order diffracted light (m2 is an integer different from m1) corresponding to a second information recording surface and the diffraction structure has negative power to diverge the m2^{th} order diffracted light, the objective lens system preferably satisfies the following condition:

P2×2/10000+0.9<f2/f1<P2×2/10000+1.1 (6)

wherein P2 is a coefficient of a quadratic term of a phase function and satisfies fD=−1/(2×P2×λ),

f1 is a focal length of the lens for the m1^{th} order diffracted light,

f1 is a focal length of the lens for the m2^{th} order diffracted light and

fD is a focal length of the diffraction structure.

The condition (6) defines power components of the phase function. If the ratio is below the lower limit or exceeds the upper limit of the condition (6), the power of the diffraction structure becomes inappropriate.

In the case where the objective lens system includes an objective lens having at least one diffraction structure for deflecting incident light by diffraction and at least two refractive surfaces for deflecting the incident light by refraction, the diffraction structure divides the incident light into m1^{th} order diffracted light (m1 is an integer) corresponding to a first information recording surface and m2^{th} order diffracted light (m2 is an integer different from m1) corresponding to a second information recording surface and the diffraction structure has negative power to diverge the m2^{th} order diffracted light, the objective lens system preferably satisfies the following condition:

P2×4/10000+0.35<WD2/WD1<P2×4/10000+0.65 (7)

wherein P2 is a coefficient of a quadratic term of a phase function and satisfies fD=−1/(2×P2×λ),

WD1 is a working distance when the m1^{th} order diffracted light is used

WD2 is a working distance when the m2^{th} order diffracted light is used and

fD is a focal length of the diffraction structure.

The condition (7) defines power components of the phase function. If the ratio is below the lower limit or exceeds the upper limit of the condition (7), the power of the diffraction structure becomes inappropriate.

### EXAMPLES

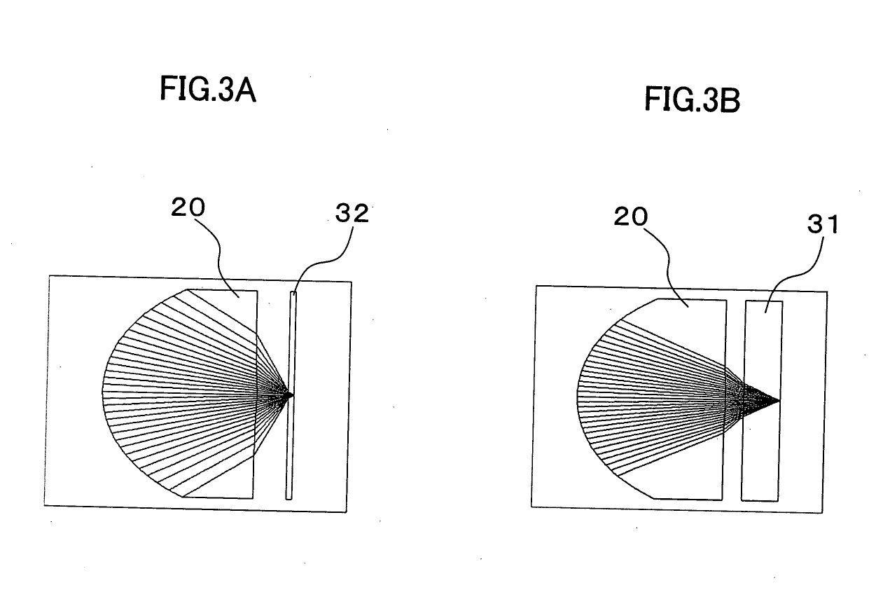

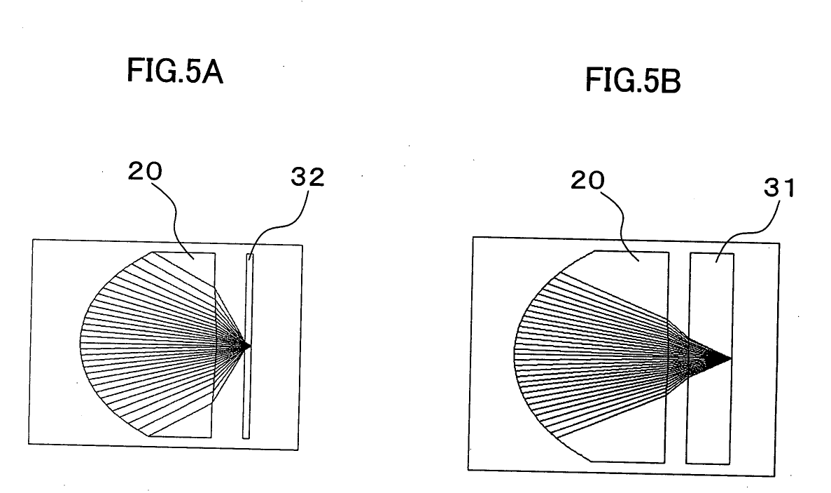

Examples of the objective lens system described in the above embodiment will be described with specific numeric values. Examples 1 and 2 correspond to Embodiment 1. FIGS. 3A and 3B are ray diagrams according to Example 1 and FIGS. 5A and 5B are ray diagrams according to Example 2. Specifically, FIGS. 3A and 5A correspond to the BD and FIGS. 3B and 5B correspond to the HD DVD.

In the following examples, the aspherical surface is given by the following formula 1:

$$X = \frac{\frac{1}{RD} {h}^{2}}{1 + \sqrt{1 - ( 1 + CC ) {( \frac{1}{RD} )}^{2} {h}^{2}}} + \sum {A}_{n} {h}^{n} \qquad [ Formula 1 ]$$

wherein X is a distance from a point on the aspherical surface at a height h from the optical axis to a tangential plane at a vertex of the aspherical surface,

h is a height from the optical axis,

RD is a radius of curvature at the vertex of the aspherical surface,

CC is a conic constant and

Aₙ is an n^{th} order aspherical surface coefficient.

In the following examples, the diffraction structure is defined by a phase function given by the following formula 2:

$$P = \sum M \cdot {P}_{m} {h}^{m} \qquad [ Formula 2 ]$$

wherein P is a phase difference function,

h is a height from the optical axis,

Pₘ is an m^{th} order phase function coefficient and

M is a diffraction order.

In each of the examples, the thickness of the protective layer, i.e., a distance from the disc surface (facing the objective lens system) to the recording surface, is optimized to 87.5 μm (BD) and 600 μm (HD DVD). The thickness of the BD protective layer, 87.5 μm, is not an actual thickness but an optimum thickness selected in view of applicability to a dual-layer BD and the design and specification of the lens.

### Example 1

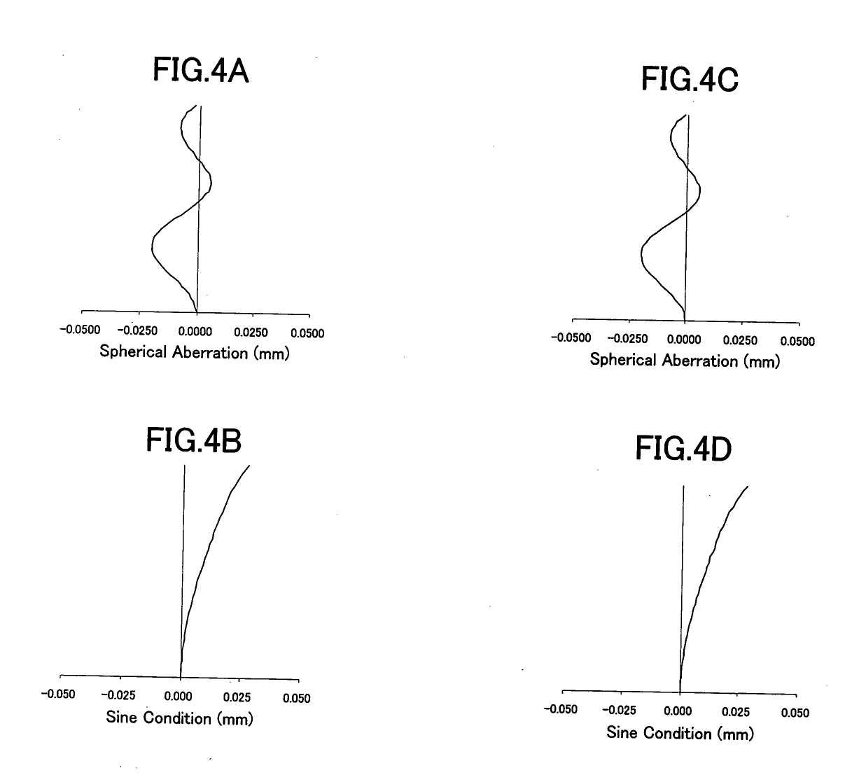

Tables 1 and 2 indicate specific numeric values of an objective lens system of Example 1. In Example 1, a laser beam of 408 nm wavelength is used. The substrate thicknesses of BD and HD DVD (base material) are 0.0875 mm and 0.6 mm, respectively. The objective lens system has focal lengths for BD and HD DVD of 1.9 mm and 2.0 mm, effective diameters for BD and HD DVD of 3.2 mm and 2.5 mm, NAs for BD and HD DVD of 0.86 and 0.6 and a thickness of 2.45 mm. FIGS. 4A to 4D show spherical aberrations and sine condition aberrations. The BD and HD DVD show axial aberrations of 4.1 mλ and 6.9 mλ in total, respectively. The axial chromatic aberrations of BD and HD DVD are 0.37 μm/nm and 0.56 μm/nm, respectively.

TABLE 1

| | BD | HD DVD | | |
|---|---|---|---|---|
| Wavelength | 0.408 | 0.408 | n1 (0.408) | 1.63009218 |
| (mm) | | | | |
| Diameter | 3.2 | 2.5 | disk (0.408) | 1.61641628 |
| (mm) | | | | |
| NA | 0.86 | 0.65 | | |
| Working | 0.5 | 0.3 | | |
| distance | | | | |
| (WD: mm) | | | | |
| Disc | 0.0875 | 0.6 | | |
| thickness | | | | |
| (DT: mm) | | | | |
| Focal | 1.9 | 2.0 | | |
| length | | | | |
| (mm) | | | | |
| Diffraction | 0 | 1 | | |
| order | | | | |

| | Radius of | | | |
|---|---|---|---|---|
| Surface | curvature | Thick- | Mate- | |
| number | at vertex | ness | rial | Remarks |
| 0 | ∞ | ∞ | Air | |
| 1 | 1.3346377 | 2.452362 | n1 | 1^{st} area (diffraction surface), |
| | | | | 2^{nd} area (aspherical surface) |
| 2 | −3.607069 | WD | Air | Aspheric surface |
| 4 | ∞ | DT | disk | Planar surface |
| 5 | ∞ | | | Planar surface |

The objective lens system of Example 1 is provided with a diffraction structure with 56 orbicular zones in an area within a diameter of 2.5 mm, i.e., a first area on the first surface of the lens corresponding to the HD DVD. The diffraction structure divides the incident light into the 0^{th} order diffracted light (70%) and the 1^{st} order diffracted light (16%). The diffraction structure is detailed in the following table.

TABLE 2

Diffraction surface

1^{st} surface, 1^{st} area, aspherical surface coefficient

| | |
|---|---|
| RD | 1.33463770 |
| CC | −0.38882878 |
| A2 | 0.00000000 |
| A4 | −0.00383807 |
| A6 | −0.00104120 |
| A8 | −0.00382660 |
| A10 | 0.00571457 |
| A12 | −0.00479486 |
| A14 | 0.00194582 |
| A16 | −0.00034004 |

1^{st} surface, 1^{st} area, phase function

| | |
|---|---|
| P2 | 237.15226 |
| P4 | −2.687372 |
| P6 | −1.1153822 |
| P8 | −4.8253762 |
| P10 | 1.0541255 |

Aspheric surface

1^{st} surface, 2^{nd} area, aspherical surface coefficient

| | |
|---|---|
| RD | 1.4975947 |
| CC | −0.3903485 |
| A0 | 0.0200519 |
| A2 | 0.0000000 |
| A4 | 0.0327239 |
| A6 | −0.0022985 |
| A8 | −0.0026976 |
| A10 | 0.0001860 |
| A12 | 0.0003688 |
| A14 | 0.0001430 |
| A16 | −0.0000810 |

2^{nd} surface, aspherical surface coefficient

| | |
|---|---|
| RD | −3.6070690 |
| CC | 0.0000000 |
| A2 | 0.0000000 |
| A4 | 0.2959403 |
| A6 | −0.2159130 |
| A8 | −0.1083075 |
| A10 | 0.1732570 |
| A12 | 0.0819477 |
| A14 | −0.1793674 |
| A16 | 0.0639260 |

FIGS. 4A to 4D are graphs illustrating the aberrations according to Example 1. FIG. 4A shows the spherical aberration for the BD, FIG. 4B shows an offence against the sine condition for the BD, FIG. 4C shows the spherical aberration on the HD DVD and FIG. 4D shows an offence against the sine condition for the HD DVD. As apparent from the figures, the aberrations are appropriately corrected.

### Example 2

Tables 3 and 4 indicate specific numeric values of an objective lens system of Example 2. In Example 2, a laser beam of 405 nm wavelength is used. The substrate thicknesses of BD and HD DVD (base material) are 0.1 mm and 0.6 mm, respectively. The objective lens system has focal lengths for BD and HD DVD of 1.7 mm and 1.8 mm, effective diameters of BD and HD DVD of 2.9 mm and 2.3 mm, NAs for BD and HD DVD of 0.86 and 0.65 and a thickness of 2.15 mm. FIGS. 7A to 7D show spherical aberrations and sine condition aberrations. The BD and HD DVD show axial aberrations of 1.0 mλ and 3.2 mλ in total, respectively. The axial chromatic aberrations of BD and HD DVD are 0.33 μm/nm and 0.62 μm/nm, respectively.

TABLE 3

| | BD | HD DVD | | |
|---|---|---|---|---|
| Wavelength | 0.408 | 0.408 | n1 (0.408) | 1.63009218 |
| (mm) | | | | |
| Diameter | 3.2 | 2.5 | disk (0.408) | 1.61641628 |
| (mm) | | | | |
| NA | 0.86 | 0.65 | | |
| Working | 0.5 | 0.3 | | |
| distance | | | | |
| (WD: mm) | | | | |
| Disc | 0.0875 | 0.6 | | |
| thickness | | | | |
| (DT: mm) | | | | |
| Focal | 1.9 | 2.0 | | |
| length | | | | |
| (mm) | | | | |
| Diffraction | 0 | 1 | | |
| order | | | | |

| | Radius of | | | |
|---|---|---|---|---|
| Surface | curvature | Thick- | Mate- | |
| number | at vertex | ness | rial | Remarks |
| 0 | ∞ | ∞ | Air | |
| 1 | 1.3346377 | 2.452362 | n1 | 1^{st} area (diffraction surface), |
| | | | | 2^{nd} area (aspherical surface) |
| 2 | −3.607069 | WD | Air | Aspheric surface |
| 4 | ∞ | DT | disk | Planar surface |
| 5 | ∞ | | | Planar surface |

The objective lens system of Example 2 is provided with a diffraction structure with 85 orbicular zones in an area within a diameter of 2.3 mm, i.e., a first area on a first surface of the lens corresponding to the HD DVD. The diffraction structure divides the incident light into the 0^{th} order diffracted light (70%) and the 1^{st} order diffracted light (16%). The diffraction structure is detailed in the following table.

TABLE 4

Diffraction surface

1^{st} surface, 1^{st} area, aspherical surface coefficient

| | |
|---|---|
| RD | 1.33463770 |
| CC | −0.38882878 |
| A2 | 0.00000000 |
| A4 | −0.00383807 |
| A6 | −0.00104120 |
| A8 | −0.00382660 |
| A10 | 0.00571457 |
| A12 | −0.00479486 |
| A14 | 0.00194582 |
| A16 | −0.00034004 |

1^{st} surface, 1^{st} area, phase function

| | |
|---|---|
| P2 | 237.15226 |
| P4 | −2.687372 |
| P6 | −1.1153822 |
| P8 | −4.8253762 |
| P10 | 1.0541255 |

Aspheric surface

1^{st} surface, 2^{nd} area, aspherical surface coefficient

| | |
|---|---|
| RD | 1.4975947 |
| CC | −0.3903485 |
| A0 | 0.0200519 |
| A2 | 0.0000000 |
| A4 | 0.0327239 |
| A6 | −0.0022985 |
| A8 | −0.0026976 |
| A10 | 0.0001860 |
| A12 | 0.0003688 |
| A14 | 0.0001430 |
| A16 | −0.0000810 |

2^{nd} surface, aspherical surface coefficient

| | |
|---|---|
| RD | −3.6070690 |
| CC | 0.0000000 |
| A2 | 0.0000000 |
| A4 | 0.2959403 |
| A6 | −0.2159130 |
| A8 | −0.1083075 |
| A10 | 0.1732570 |
| A12 | 0.0819477 |
| A14 | −0.1793674 |
| A16 | 0.0639260 |

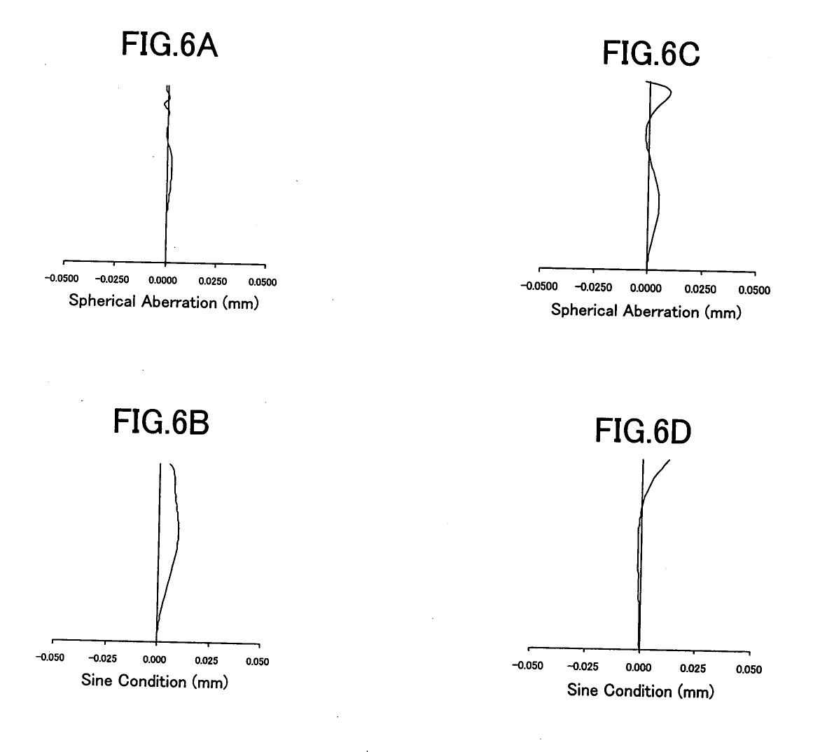

FIGS. 6A to 6D are graphs illustrating the aberrations according to Example 2. FIG. 6A shows the spherical aberration for the BD, FIG. 6B shows an offence against the sine condition for the BD, FIG. 6C shows the spherical aberration on the HD DVD and FIG. 6D shows an offence against the sine condition for the HD DVD. As apparent from the figures, the aberrations are appropriately corrected.

The optical pickup of the present invention is suitably used for information devices such as personal computers, imaging and acoustic devices such as next-generation DVD recorders, other various devices capable of storing, inputting and outputting information using an optical disc and contributes to improvement of functionality of these devices.

It should be noted that the present invention is not limited to the above embodiments and various modifications are possible within the spirit and essential features of the present invention. The above embodiments shall be interpreted as illustrative and not in a limiting sense. The scope of the present invention is specified only by the following claims and the description of the specification is not limitative at all. Further, it is also to be understood that all the changes and modifications made within the scope of the claims fall within the scope of the present invention.

What is claimed is:

1. An objective lens system for forming a spot of a laser beam of λ wavelength on a first information recording surface through a disc protective layer having a first thickness and a second information recording surface through a disc protective layer having a second thickness greater than the first thickness, the objective lens system comprising:
an objective lens having at least one diffraction structure for deflecting incident light by diffraction and at least two refractive surfaces for deflecting the incident light by refraction, wherein
the diffraction structure divides the incident light into m1^{th} order diffracted light (m1 is an integer) corresponding to the first information recording surface and m2^{th} order diffracted light (m2 is an integer different from m1) corresponding to the second information recording surface and has negative power to diverge the m2^{th} order diffracted light.

2. The objective lens system of claim 1, wherein
the diffraction structure is formed on one of the refractive surfaces from which the light enters and
the objective lens system is a single objective lens.

3. The objective lens system of claim 1 which satisfies the following condition:
−0.8<ΦD/ΦL<−0.2
wherein ΦD is power of the diffraction structure for the m2^{th} order diffracted light and
ΦL is synthetic power of the refractive surfaces.

4. The objective lens system of claim 1 which satisfies the following condition:
0.2<|ΔCA1−ΔCA2|<0.5
wherein ΔCA1 is axial chromatic aberration for the m1^{th} order diffracted light and
ΔCA2 is axial chromatic aberration for the m2^{th} order diffracted light.

5. The objective lens system of claim 1 which satisfies the following condition:
1.03<f1/f2<1.2
wherein f1 is a focal length of the lens for the m1^{th} order diffracted light,
f2 is a focal length of the lens for the m2^{th} order diffracted light and
m1>m2.

6. The objective lens system of claim 1 which satisfies the following condition:
0.9<f2/f1<1.1
wherein f1 is a focal length of the lens for the m1^{th} order diffracted light and
f2 is a focal length of the lens for the m2^{th} order diffracted light.

7. The objective lens system of claim 1 which satisfies the following condition:
R1/f1≧0.66 or R1/f2≧0.66
wherein R1 is a radius of curvature of the entrance surface of the lens,
f1 is a focal length of the lens for the m1^{th} order diffracted light and
f2 is a focal length of the lens for the m2^{th} order diffracted light.

8. The objective lens system of claim 1 which satisfies the following condition:
P2×2/10000+0.9<f2/f1<P2×2/10000+1.1
wherein P2 is a coefficient of a quadratic term of a phase function and satisfies fD=−1/(2×P2×λ),
f1 is a focal length of the lens for the m1^{th} order diffracted light,
f2 is a focal length of the lens for the m2^{th} order diffracted light and
fD is a focal length of the diffraction structure.

9. The objective lens system of claim 1 which satisfies the following condition:
P2×4/10000+0.35<WD2/WD1<P2×4/10000+0.65
wherein P2 is a coefficient of a quadratic term of a phase function and satisfies fD=−1/(2×P2×λ),
WD1 is a working distance when the m1^{th} order diffracted light is used,
WD2 is a working distance when the m2^{th} order diffracted light is used and
fD is a focal length of the diffraction structure.

10. An optical pickup comprising:
a light source for emitting a laser beam;
a collimator lens for converting the laser beam from the light source to a collimated beam; and
the objective lens system of any one of claims 1 to 9.
